(19) United States
(12) Patent Application Publication
(10) Pub. No.: US 2006/0148666 A1
(43) Pub. Date: Jul. 6, 2006

(54) Aqueous cleaner with low metal etch rate

(75) Inventors: Darryl W. Peters, Stewartsville, NJ (US); Ewa B. Oldak, Bethlehem, PA (US); Elizabeth L. Walker, Nazareth, PA (US); Jeffrey A. Barnes, Nazareth, PA (US); Shahriar Naghshineh, Allentown, PA (US)

Correspondence Address: RATNERPRESTIA, P O BOX 980, VALLEY FORGE, PA, 19482-0980, US

(73) Assignee: Advanced Technology Materials Inc.

(21) Appl. No.: 11/027,845

(22) Filed: Dec. 30, 2004

(51) Int. Cl. C11D 7/32

(52) U.S. Cl. 510/175

(57) ABSTRACT

A cleaning solution is provided for cleaning copper-containing microelectronic substrates, particularly for post etch, post-CMP or Via formation cleaning. The cleaning solution comprises a quaternary ammonium hydroxide, an organic amine, a corrosion inhibitor, and water. A preferred cleaning solution comprises tetramethylammonium hydroxide, monoethanolamine, gallic acid, and water. The pH of cleaning solution is greater than 10.

### FIELD OF THE INVENTION

The present invention relates to post etch and post chemical-mechanical polishing (post-CMP) cleaning operations, and more specifically to post etch and post-CMP cleaning solutions for copper-containing microelectronic substrates.

### BACKGROUND OF THE INVENTION

The present day fabrication of semiconductor devices is a complex, multi-step process. The CMP process and post etch processes are now well established enabling technology used by most advanced semiconductor operations for manufacturing of semi-conductor devices with design geometries less than 0.35 micron.

The CMP processes involve holding and rotating a thin, flat substrate of the semiconductor material against a wetted polishing surface under controlled chemical, pressure and temperature conditions. A chemical slurry containing a polishing agent, such as alumina or silica, is used as the abrasive material. In addition, the chemical slurry contains selected chemicals which etch various surfaces of the substrate during processing. The combination of mechanical and chemical removal of material during polishing results in superior planarization of the surface.

The CMP process, however, leaves contamination on the surfaces of the semiconductor substrate. This contamination is comprised of abrasive particles from the polishing slurry which may consist of alumina or silica, with reactive chemicals added to the polishing slurry. In addition, the contaminant layer may comprise reaction products of the polishing slurry and the polished surfaces. It is necessary to remove the contamination prior to subsequent processing of the semiconductor substrate in order to avoid degradation in device reliability and to avoid the introduction of defects which reduce the manufacturing process yield. Thus, post-CMP cleaning solutions have been developed to cleanse the substrate surface of CMP residuum.

Alkaline solutions based on ammonium hydroxide have been traditionally used in post-CMP cleaning applications. To date, most CMP applications have been directed to aluminum, tungsten, tantalum, and oxide-containing surfaces.

However, copper is increasingly becoming a material of choice in the production of interconnects in semiconductor fabrication. Copper is replacing aluminum as the metal of choice in such fabrication. Conventional post-CMP processes are inadequate for cleaning surfaces containing copper. Copper, copper oxide, and the slurry particles are the contaminants that exist on the copper-containing surface following this CMP process. The copper surface contamination diffuses quickly in silicon and silicon dioxide, and therefore, it must be removed from all wafer surfaces to prevent device failure.

Effective post-CMP cleaning solutions are disclosed and claimed in U.S. Pat. No. 6,194,366 B1 now owned by the Assignee of the present application. Patentees disclose a cleaning composition containing tetramethyl-ammonium hydroxide (TMAH), monoethanol amine (MEA), a corrosion inhibitor being one of gallic acid ascorbic acid or mixtures thereof and water. The basic composition can be used in a dilute form for effective Post CMP cleaning.

Nam, U.S. Pat. No. 5,863,344, discloses a cleaning solution for semiconductor devices containing tetramethyl ammonium hydroxide, acetic acid, and water. The solution preferably contains a volumetric ratio of acetic acid to tetramethyl ammonium hydroxide ranging from about 1 to about 50.

Ward, U.S. Pat. No. 5,597,420, discloses a post etch aqueous stripping composition useful for cleaning organic and inorganic compounds from a substrate that will not corrode or dissolve metal circuitry in the substrate. The disclosed aqueous composition contains preferably 70 to 95 wt % monoethanolamine and a corrosion inhibitor at about 5 wt % such as catechol, pyrogallol or gallic acid.

Ward, U.S. Pat. No. 5,709,756, discloses a post etch cleaning composition containing about 25 to 48 wt % hydroxylamine, 1 to 20 wt % ammonium fluoride, and water. The pH of the solution is greater that 8.The solution may further contain a corrosion inhibitor such as gallic acid, catechol, or pyrogallol.

Ilardi et al., U.S. Pat. No. 5,466,389, discloses an aqueous alkaline cleaning solution for cleaning microelectronic substrates. The cleaning solution contains a metal ion-free alkaline component such as a quaternary ammonium hydroxide (up to 25 wt %), a nonionic surfactant (up to 5 wt %), and a pH-adjusting component, such as acetic acid, to control the pH within the range of 8 to 10.

Schwartzkopf et al., European Patent No. 0647884A1 discloses photoresist strippers containing reducing agents to reduce metal corrosion. This patent teaches the use of ascorbic acid, gallic acid, and pyrogallol among others for the control of metal corrosion in alkali containing components.

U.S. Pat. No. 5,143,648 to Satoh et al., which is herein incorporated by reference discloses novel ascorbic acid derivatives as antioxidants.

Ward U.S. Pat. No. 5,563,119 discloses a post etch aqueous stripping composition consisting of an alkanolamine, tetraalkyammonium hydroxide, and a corrosion inhibitor for cleaning organic residue from aluminized inorganic substrates.

There is a need to further improve post-CMP cleaning compositions for copper-containing surfaces to not only clean residuals particles and contaminants from surfaces of devices but to further prevent or substantially lessen corrosion of the copper-containing substrate. Such a post-CMP cleaning composition must also refrain from attacking the process equipment used in the post-CMP process. Such a post-CMP cleaning composition should also be economical, work effectively through a wide temperature range, and preferably contain chemical components of comparatively lower toxicity. Such a post-CMP cleaning composition should also be useful in cleaning operations following CMP processes utilizing alumina or silica-based slurries.

### SUMMARY OF THE INVENTION

In one aspect the present invention is a cleaning solution for cleaning copper-containing microelectronic substrates comprises 0.122 to 0.155 wt % tetramethylammonium hydroxide, 0.22 to 3.48 wt % monoethanolamine, 0.084 to 1.36 wt % gallic acid, balance deionized water. The pH of the solution should be greater than 10.

In another aspect the present invention is a post-CMP cleaning solution for cleaning microelectronic substrates comprising 1.0 to 1.5 wt % of a concentrate inserting essentially of tetramethylammonium hydroxide in an amount in the range from about 8.0 wt % to about 12.4 wt %, monoethanolamine in an amount in the range from about 14.4 wt % to about 27.8 wt %, gallic acid in an amount in the range from about 5.6 wt % to about 10.9 wt %, balance deionized water; and 98.5 to 99 wt % deionized water.

In yet another aspect the present invention is a cleaning composition wherein a concentrate containing 8.0 wt % to 12.4 wt % TMAH, 14.9 to 27.8 wt % MEA, 5.6 to 10.9 wt % gallic acid, balance deionized water is diluted (mixed) in a ratio of 1 part concentrate to between 100 and 150 parts deionized water that can be used in a static bath or a bath agitated ultrasonically to effectuate post-CMP cleaning.

In still another embodiment the present invention is a cleaning composition consisting essentially of 0.033 to 0.140 wt % TMAH, 0.06 to 0.30 wt % MEA, 0.013 to 0.07 wt % corrosion inhibitor selected from the group consisting of gallic acid, ascorbic acid and mixtures thereof, balance deionized water.

### BRIEF DESCRIPTION OF THE DRAWING

FIG. 1 is a plot of surface roughness against processing conditions for various cleaning compositions according to the invention.

FIG. 2 is a composite of scanning electron microscope (SEM) photomicrographs of short-loop patterned wafer segments prior to treatment with a composition according to the present invention.

FIG. 3a is a composite of SEM photomicrographs of the device shown in FIG. 1 treated post etch with a composition according to the invention without using ultrasonic agitation of the bath.

FIG. 3b is a composite of SEM photomicrographs of a device shown in FIG. 1 treated post etch with a composition according to the invention without using ultrasonic agitation of the bath.

FIG. 3c is a composite of SEM photomicrographs of a device shown in FIG. 1 treated post etch with a composition according to the invention using ultrasonic agitation of the bath.

FIG. 3d is a composite of SEM photomicrographs of a device shown in FIG. 1 treated post etch with a composition according to the invention using ultrasonic agitation of the bath.

FIG. 4 is a composite of scanning electron microscope (SEM) photomicrographs of a device similar to that of FIG. 1 prior to treatment with a composition according to the invention.

FIG. 5a is composite of SEM photomicrographs of the device of FIG. 4 treated post etch with a composition according to the invention without using ultrasonic agitation of the bath.

FIG. 5b is composite of SEM photomicrographs of the device of FIG. 4 treated post etch with a composition according to the invention without using ultrasonic agitation of the bath.

FIG. 5c is composite of SEM photomicrographs of the device of FIG. 4 treated post etch with a composition according to the invention using ultrasonic agitation of the bath.

FIG. 5d is a composite of SEM photomicrographs of the device of FIG. 2 treated post etch with a composition according to the invention using ultrasonic agitation of the bath.

FIG. 6 is a composite of SEM photomicrographs of a post etch short-looped patterned wafer segments prior to treatment with a composition according to the present invention.

FIG. 7 is a composite of SEM photomicrographs of the device of FIG. 6 treated post etch with a composition according to the invention.

FIG. 8 is a composite of SEM photomicrographs of a short-looped patterned wafer segments post etch and prior to treatment with a composition according to the present invention.

FIG. 9a is a composite of SEM photomicrographs of the device of FIG. 8 treated post etch with a composition according to the invention.

FIG. 9b is a composite of SEM photomicrographs of the device of FIG. 8 treated post etch with a composition according to the invention.

FIG. 9c is a composite of SEM photomicrographs of the device of FIG. 8 treated post etch with a composition according to the invention.

FIG. 9d is a composite of SEM photomicrographs of the device of FIG. 8 treated with a composition according to the invention.

FIG. 10a is a composite of SEM photomicrographs of the device of FIG. 8 treated with a composition according to the invention.

FIG. 10b is a composite of SEM photomicrographs of the device of FIG. 8 treated with a composition according to the invention.

### DETAILED DESCRIPTION OF THE INVENTION

Cleaning copper-containing substrates following CMP processing are generally referred to as “post-Cu CMP” or “post-CMP copper clean”. A “copper-containing microelectronic substrate” is understood herein to refer to a substrate surface manufactured for use in microelectronic, integrated circuit, or computer chip applications, wherein the substrate contains copper-containing components. Copper-containing components may include, for example, metallic interconnects that are predominately copper or a copper alloy. It is understood that the microelectronic surface may also be composed of semiconductor materials, such as TiN, Ta, TiW (as copper diffusion barrier metals), and silica. Generally, a copper-containing microelectronic substrate contains about 1-20% Cu, including the copper interconnects.

The cleaning solution of the invention may find application for any cleaning operation during the fabrication of microelectronic substrates, such as semiconductor wafers. Most notably, such cleaning applications include post-Via formations and post-CMP processes. The fabrication of conventional semiconductor wafers entails many steps requiring planarization, followed by the removal of residual product from the planarization process.

The cleaning solution of the invention comprise tetramethyl ammonium hydroxide, an ethanol amine, gallic acid and the balance deionized water.

The pH of a cleaning solution of the invention is greater than 10.

In a preferred embodiment of the cleaning solution of the invention is prepared from a concentrate comprising tetramethylammonium hydroxide (“TMAH”), monoethanolamine (“MEA”), gallic acid, and water. The concentrate solution is then diluted using deionized water in ratios of from 1 part concentrate to between 100 and 150 parts deionized water. In the dilute solution TMAH is present in the solution in an amount in the range from about 0.15 wt % to about 1.25 wt %; MEA is present in the solution in an amount in the range from about 0.4 wt % to about 2.25 wt %; gallic acid is present in the solution in an amount in the range from about 0.09 wt % to about 0.9 wt %; and the balance water.

The constituents of the cleaning solution of the invention may be mixed together in any order. The order of addition is exemplified with respect to the preferred embodiment containing TMAH, MEA, gallic acid, and water. In a preferred method of preparation, 50% of the water in the final solution is added to all of the MEA, followed by addition of the gallic acid. The remaining 50% of water is added when the gallic acid is dissolved. The TMAH is then added and the composition mixed under low shear-stress conditions for about 10 minutes. The resulting mixture is then filtered through a 0.1 micron filter.

The components of the preferred embodiment of a cleaning solution of the invention are commercially available.

An important feature of the cleaning solution of the invention is that the non-aqueous constituents (the constituents other than water) are present in the solution in comparatively smaller quantities than prior art cleaning solutions. A cleaning solution of the invention is therefore more “dilute” than prior art post-CMP cleaning solutions. This is an economic advantage since an effective cleaning solution can be formulated more cheaply, which is of importance since such post-CMP cleaning solutions are used in large quantities.

In an alternative embodiment of the invention, a concentrated composition is provided that may be diluted to be used as a cleaning solution. A concentrated composition of the invention, or “concentrate”, advantageously permits a CMP process engineer, for example, to dilute the concentrate to the desired strength and pH. A concentrate also permits longer shelf life, and easier shipping and storage of the product.

A concentrate of the invention preferably comprises TMAH in an amount in the range from about 8.0 to about 12.4 wt %, MEA in an amount in the range from about 14.4 to about 27.8 wt %, gallic acid in an amount in the range from about 5.6 to about 10.9 wt %, and the balance water (preferably deionized water).

In one embodiment a concentrate of the invention is preferably diluted for use in post-CMP cleaning applications by adding deionized water until the concentrate is present from about 1.0 wt % to about 1.5 wt % of the prepared cleaning solution.

The cleaning solution of the invention may be employed for cleaning microelectronic substrates at temperatures ranging from ambient conditions to about 70° C. It is generally recognized that cleaning improves as temperature increases. At temperatures greater than about 70° C., evaporation of constituent cleaning solution species risks adversely altering the chemistry of the cleaning system over time in a process open to ambient conditions.

The cleaning solution of the invention, as noted, has a pH greater than 10. More preferably, the pH of a cleaning solution of the invention is maintained in the range from about 11.0 to about 12.2.A pH greater than 10 is necessary to obtain a negative zeta potential on the surface of the substrate and the remaining particulates during the cleaning operation.

The cleaning solution of the invention meets generally accepted industry cleaning performance standards for post-CMP applications. A common industrial cleaning target is a particle count on the substrate wafer of less than 20 particles greater than 0.2 microns in size for a 200 mm wafer, with a 5 mm edge exclusion.

The cleaning solution of the invention limits copper corrosion to smoothing of the surface and does not damage processing equipment.

The cleaning solution of the invention may be used with a large variety of conventional cleaning tools, including Verteq single wafer megasonic Goldfinger, OnTrak systems, DDS (double-sided scrubbers) and Megasonic batch wet bench systems.

The cleaning solution of the invention may be used successfully on surfaces containing copper, tungsten, and/or silica.

Via cleaning is one application of the cleaning solution of the invention. Vias are holes etched in microelectronic substrates to provide a conduit for connecting metal layers. Etching the substrate surface with a gaseous etchant forms Vias. The substrate is commonly a dielectric material, such as Fluorinated Silica Glass (FSG). The residue remaining on the substrate surface and Via walls must be removed following the etching process. The residue is often referred to as “side wall polymer”, as it is also found on the vertical walls of the Via. Etching residue may also be located at the bottom of the Via, on top of the metal. The cleaning solution of the invention does not react with or affect the exposed dielectric material.

A series of tests were conducted to determine whether compositions according to the invention could remove an organic-copper post-etch/ash residue from test wafers supplied by Texas Instruments in Dallas, Tex. According to the supplier there was an intermittent problem with their device, which contains single damascene copper/OSG levels, where post-etch/ash residue remaining after their POR clean caused yield losses. According to the present invention a concentrate containing 5 wt % TMAH, 9 wt % MEA, 3.5 wt % gallic acid, balance deionized water was diluted in a ratio of 100 parts water to 1 parts concentrate with DI water. This solution was able to remove the etch/ash residue without significant roughening of the exposed copper. There also was no undercut of the OSG pattern on short-loop test wafers.

Additional short-loop patterned test wafers containing OSG patterns on ECD copper and blanket ECD copper wafers were used in testing of the composition of the invention.

The following non-contact cleaning processes were tested;

1. 1 Part concentrate to 20 parts deionized water with and without ultrasonic agitation

2. 1 Part concentrate to 100 parts deionized water with and without ultrasonic agitation

3. 1 Part concentration to 200 parts deionized water without agitation

Cleaning tests were evaluated for effectiveness by SEM inspection (5 kV) looking for the absence of the post-etch/ash residue. Copper roughness was evaluated from the RMS value from AFM images. Dielectric undercut was determined by cross sectioning wafer segments using a focused ion beam (FIB) followed by SEM inspection.

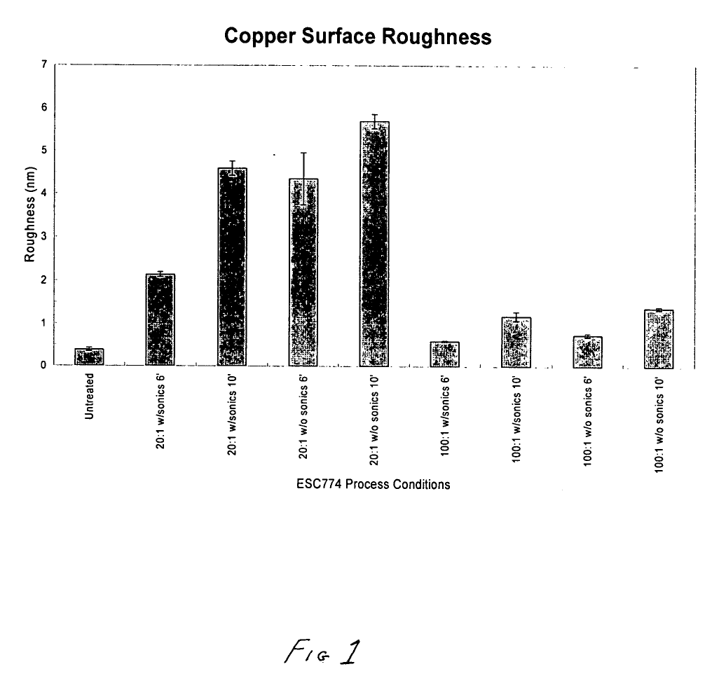

FIG. 1 contains an Excel plot showing the measured copper surface roughness (RMS) from the average of 3 AFM measurements per process condition along with an estimated error in the RMS value. Roughness values of less than 3 nm were achieved for several process conditions as depicted in the plot.

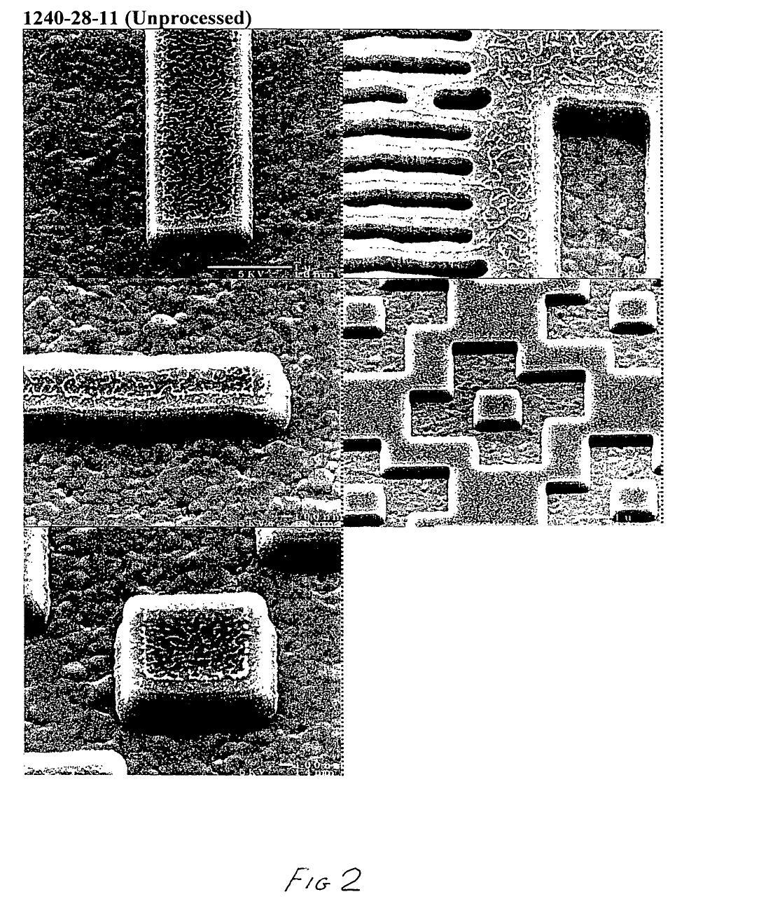

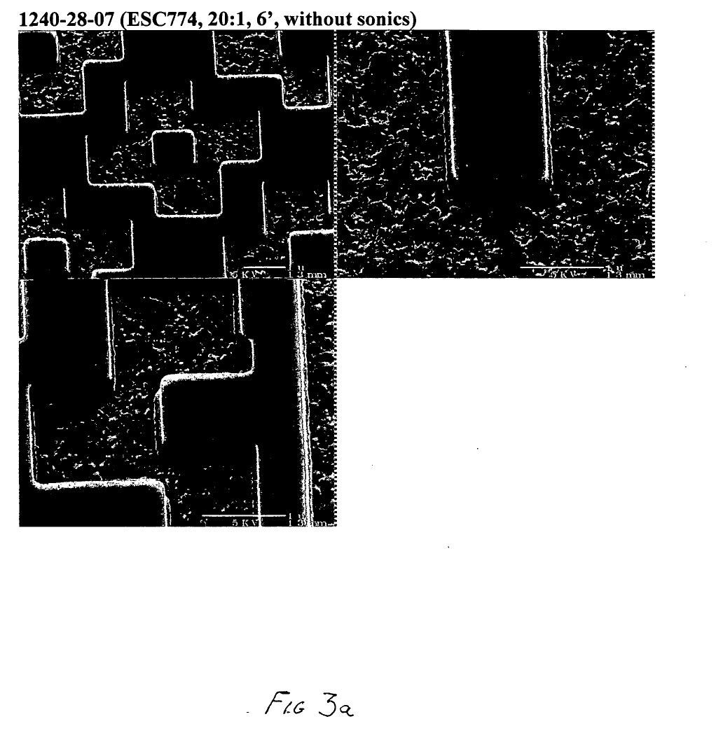

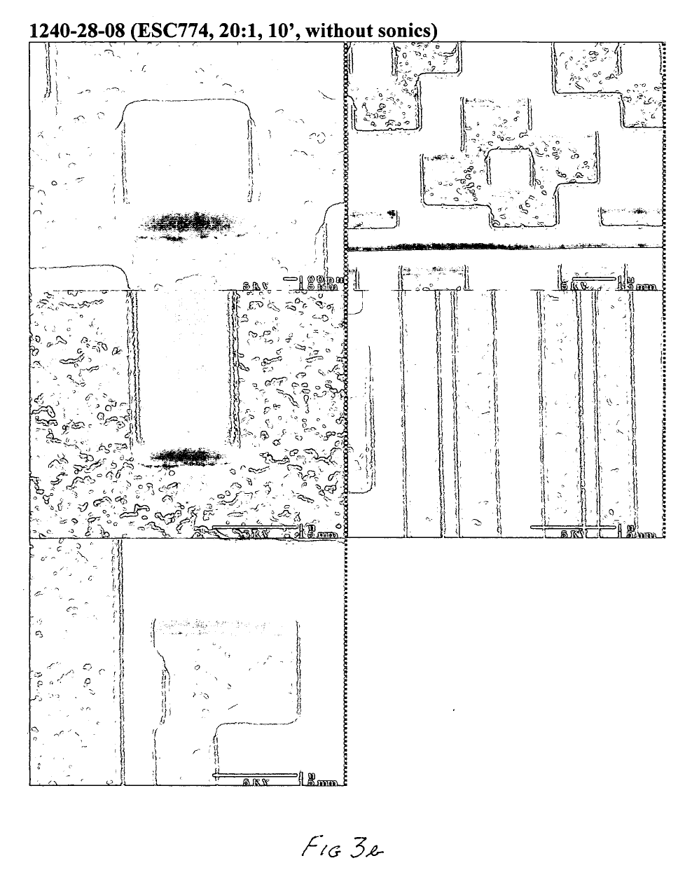

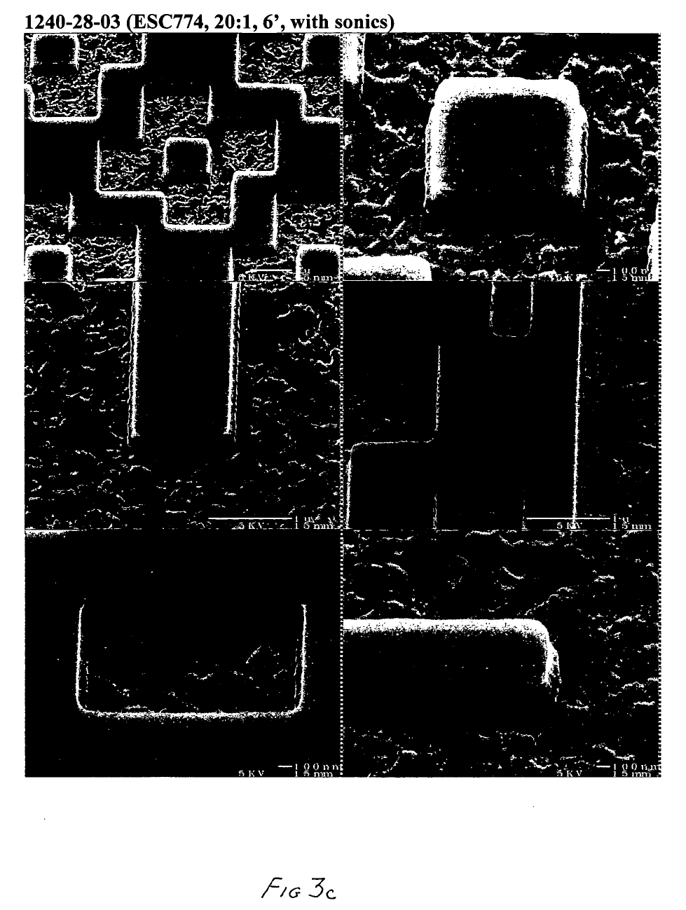

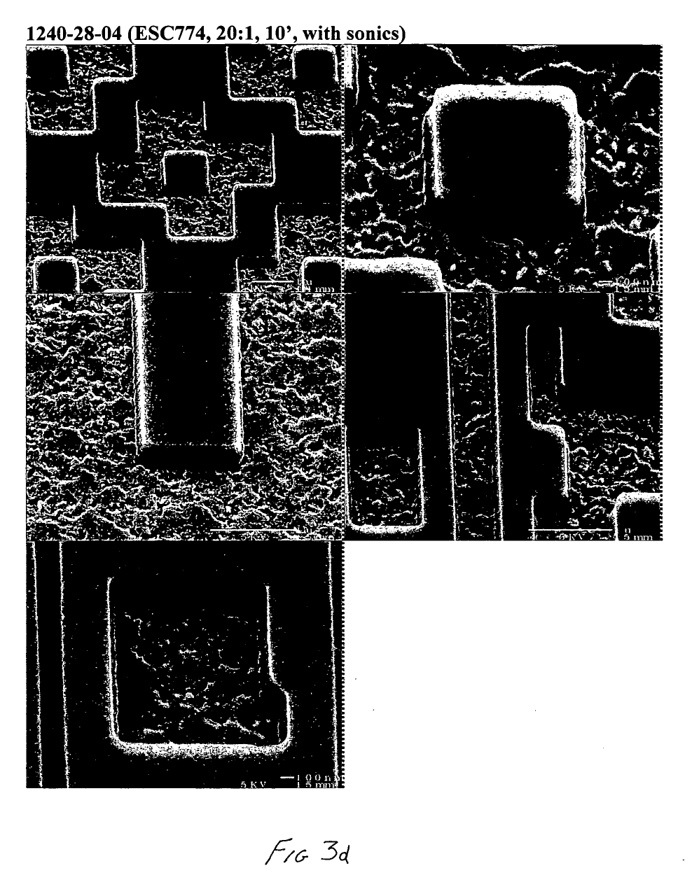

FIG. 2 contains composite SEM photomicrographs of a short-loop patterned wafer segment prior to processing with compositions according to the present invention. FIG. 3a and FIG. 3b are SEM photomicrographs of a device of FIG. 2 processed in a solution of 20 parts water to 1 part concentrate without ultrasonic agitation of the bath. FIG. 3c and FIG. 3d are SEM photomicrographs of device of FIG. 2 processed in a solution of 20 parts deionized water and 1 part concentrate with ultrasonic agitation of the bath. In all cases for the processed wafer segments of FIGS. 3a through 3d, the etch/ash residue was removed but the copper roughening was severe, possibly due to the age of the test wafers. The composition used in these tests will dissolve cupric oxide and the roughening seen in the SEMs could be due to dissolution of oxide and plasma damage to the copper.

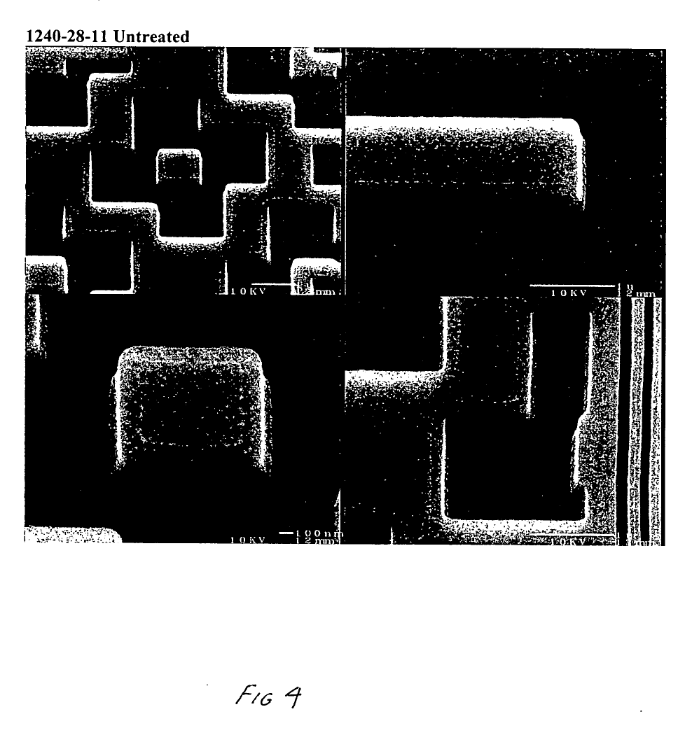

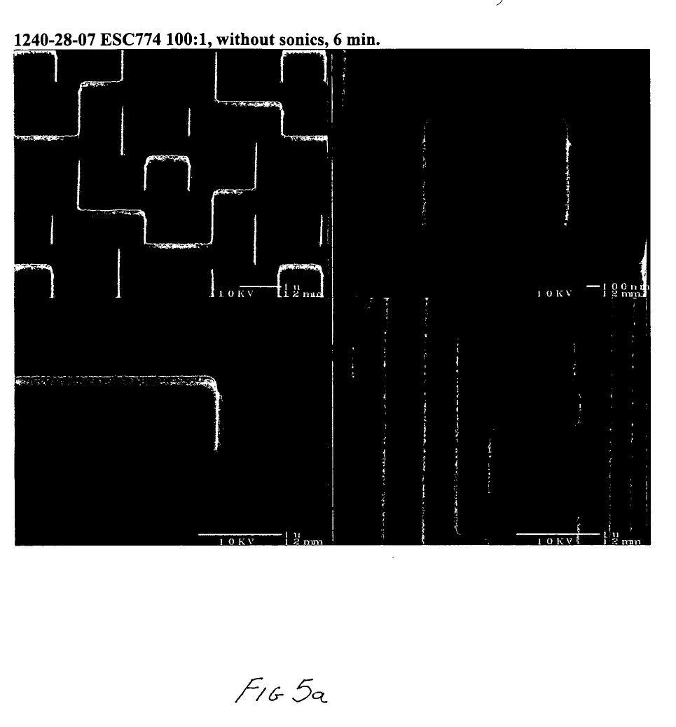

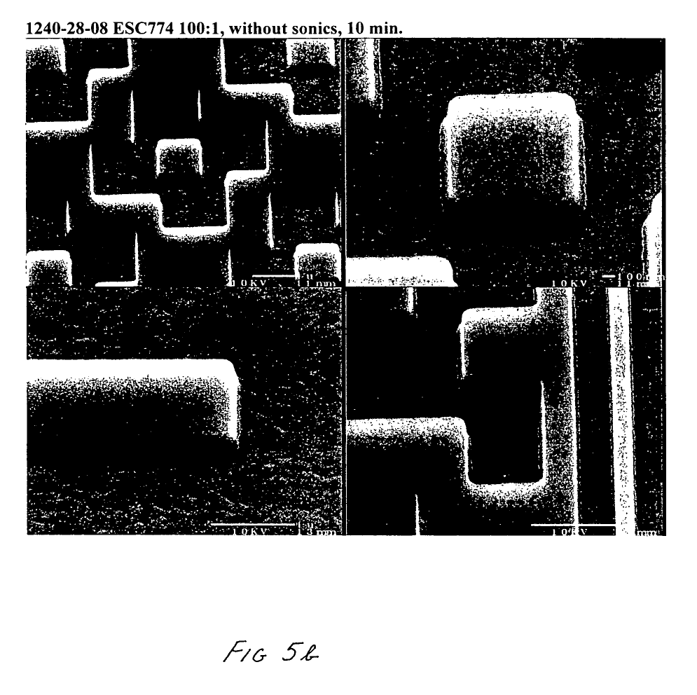

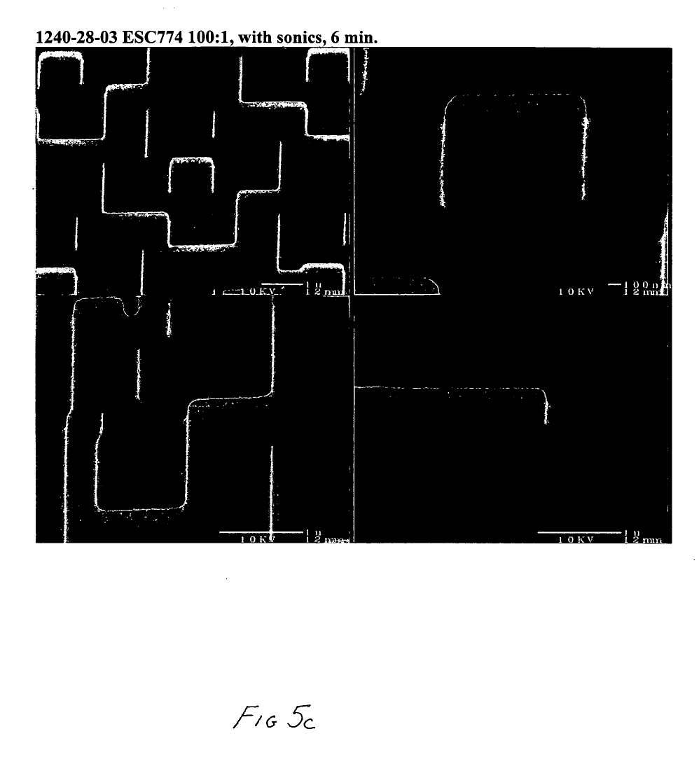

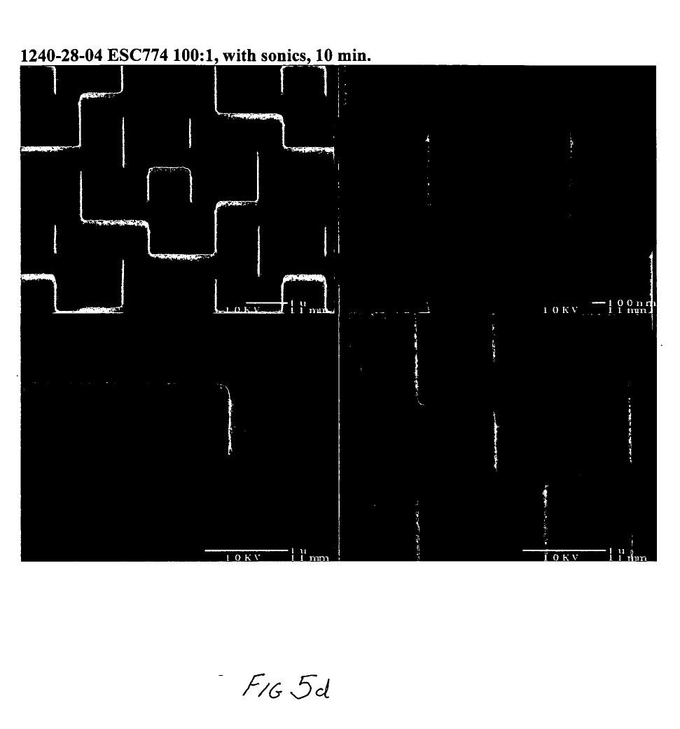

FIG. 4 is a composite of SEM photomicrographs of short-looped wafer segments prior to processing with compositions according to the invention. FIG. 5a and 5b are composite SEM photomicrographs of the device of FIG. 4 treated with a composite consisting of 1 part concentrate and 100 parts deionized water in a bath without ultrasonic agitation for 6 minutes and 10 minutes respectively. FIG. 5c and FIG. 5d are composite SEM photomicrographs of the device of FIG. 4 treated with a composition consisting of 1 part concentrate and 100 parts deionized water in a bath with ultrasonic agitation for 6 minutes and 10 minutes respectively.The copper roughening while severe at 20:1, was very acceptable at 100:1 dilutions. At a dilution of 100:1 with and without sonics agitation, the etch residue was removed and the copper roughening was minimal as is apparent from the various photomicrographs.

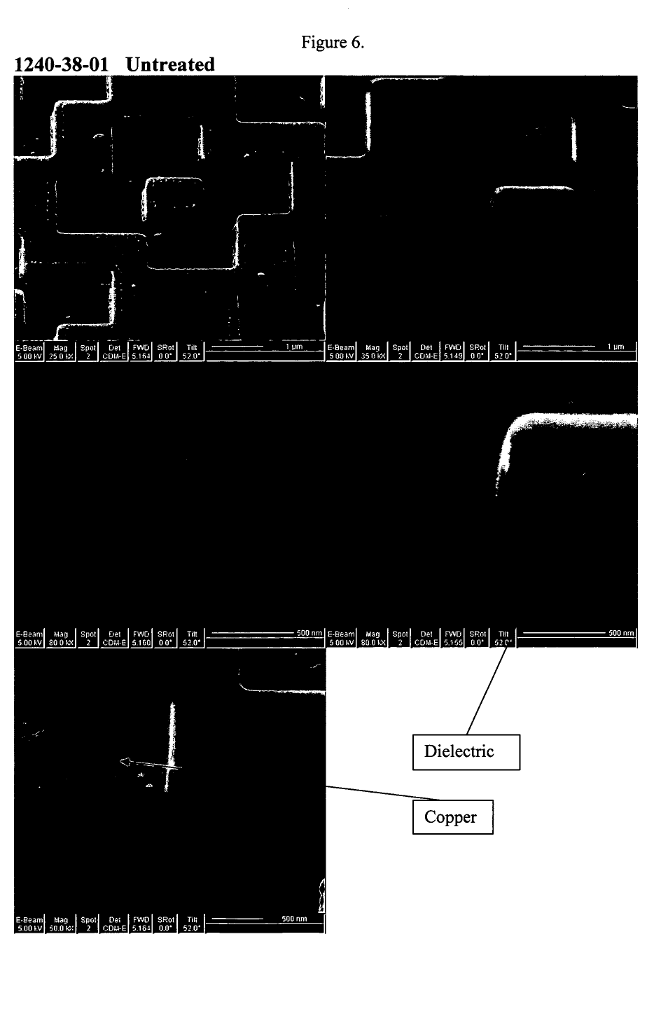

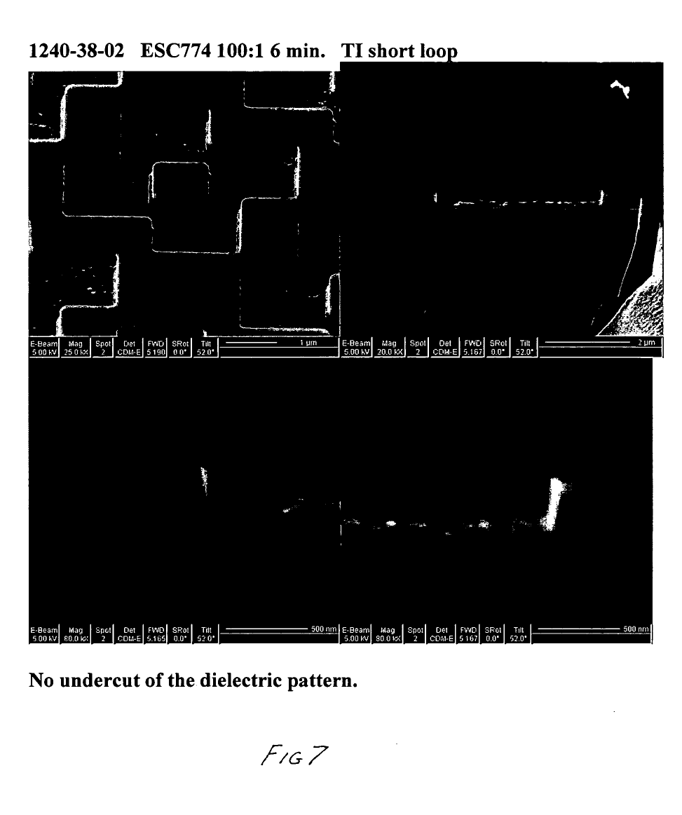

FIG. 6 is a composition of SEM photomicrographs of a wafer segment with ECD copper prior to processing according to the invention. FIG. 7 is a composite of SEM photomicrograph of the device of FIG. 6 treated in a bath of 1 part concentrate to 100 parts deionized water for 6 minutes showing no undercut of the dilution pattern or copper roughening. FIG. 7 contains focused ion beam (FIB) cross sections of patterned wafer segments after processing indicating no undercut of the OSG pattern. The roughening was less than 2 nm for all processed wafer segments.

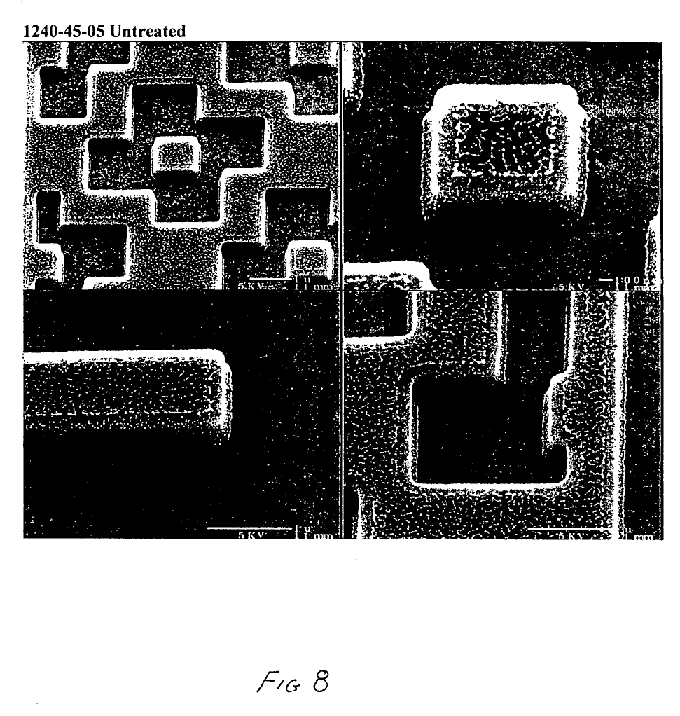

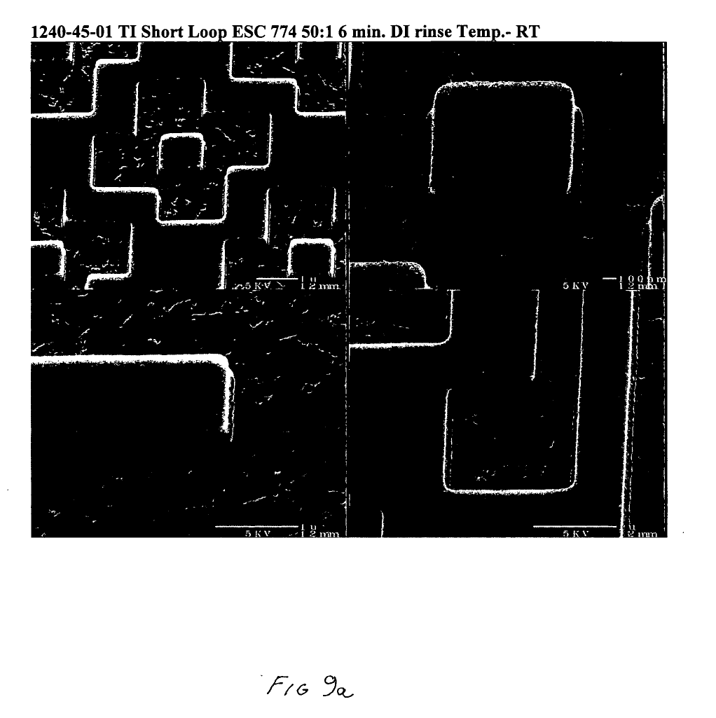

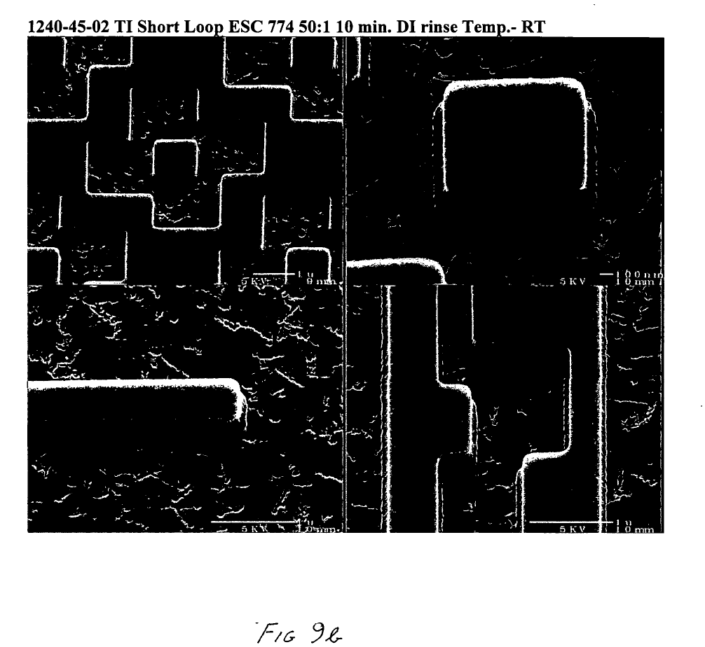

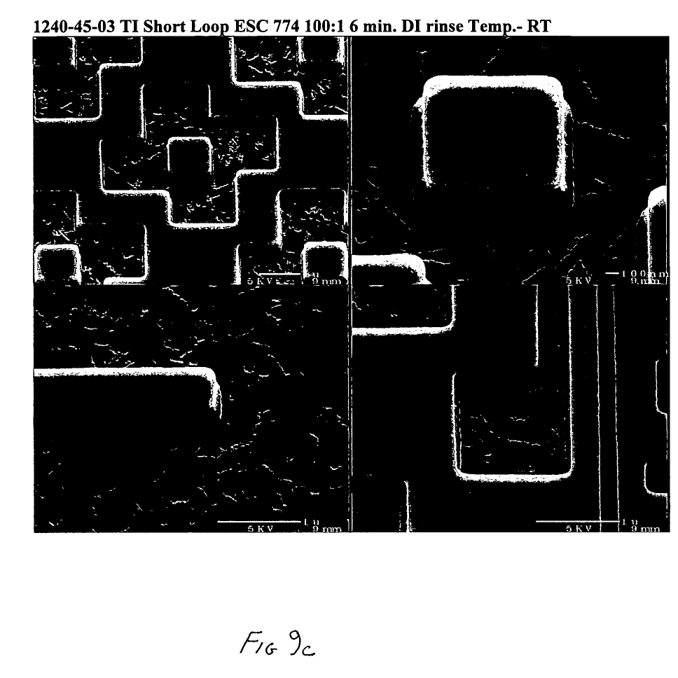

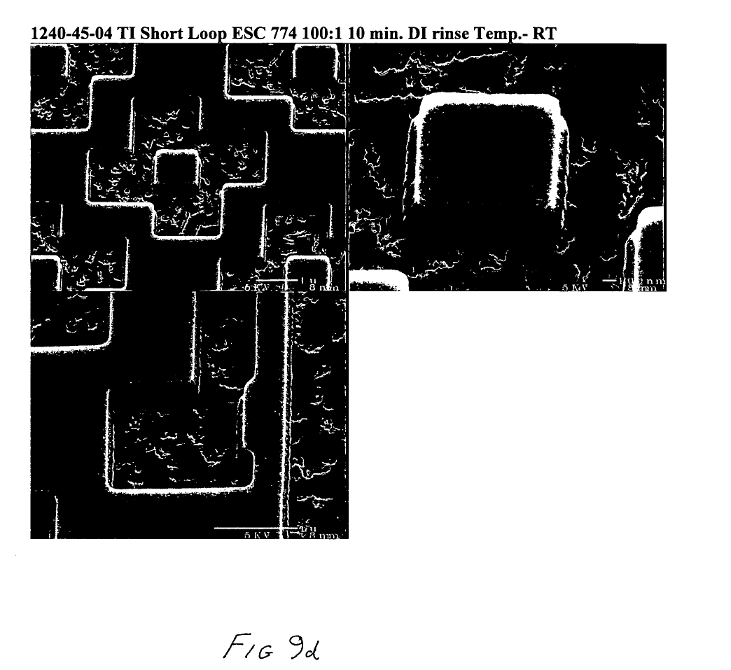

FIG. 8 is a composite of SEM photomicrographs of another short-loop wafer prior to processing in a static bath with compositions according to the present invention. FIG. 9a and FIG. 9b are composite SEM photomicrographs of the device of FIG. 8 treated in a bath containing 1 part concentrate and 50 parts deionized water.

FIG. 9c and FIG. 9d are composite SEM photomicrographs of the device of FIG. 8 treated in a bath containing 1 part concentrate and 100 parts deionized water. It is believed the level of copper roughening was severe due to the age of the wafers. The roughening appears to be due to removal of a heavy oxide layer.

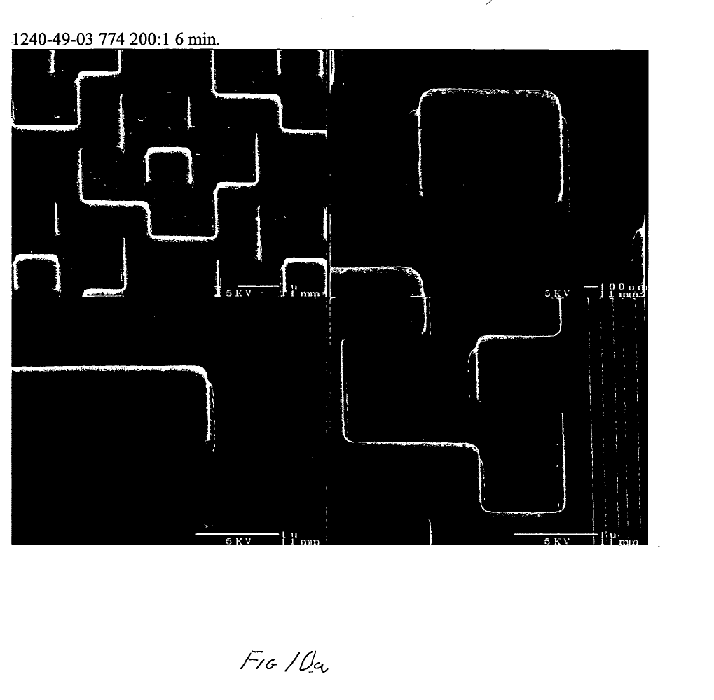

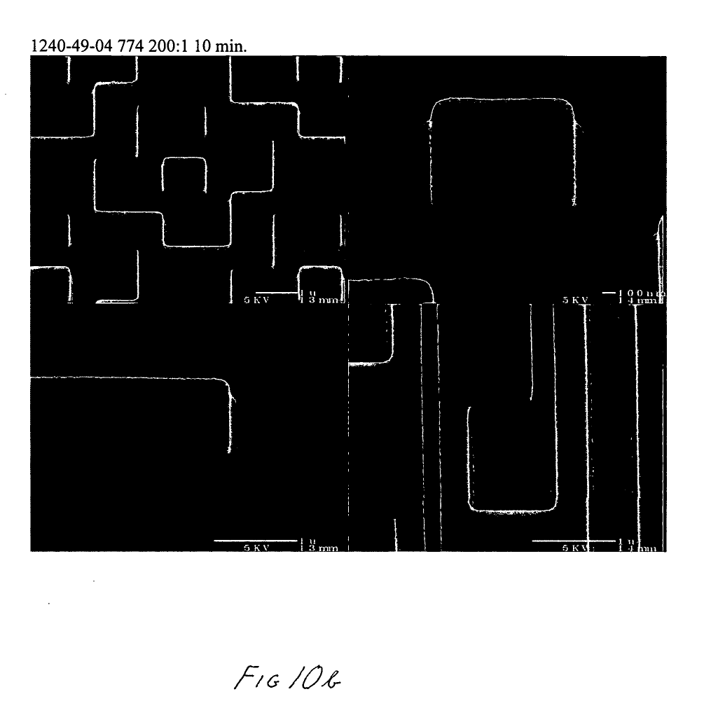

FIG. 10a and FIG. 10b are composite SEM photomicrographs of the device of FIG. 8 treated in a bath containing 1 part concentrate and 200 parts deionized water. The devices were clean with low to moderate copper roughening.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A cleaning solution for cleaning microelectronic substrates, comprising:
1.0 to 1.5 wt % of a concentrate consisting essentially of tetramethyl ammonium hydroxide in an amount in the range of about 8.0 wt % to about 12.4 wt %, monoethanolamine in an amount in the range from about 14.4 wt % to about 27.8 wt %, gallic acid in an amount in the range from about 5.6 wt % to about 10.9 wt %, balance deionized water; and 98.5 to 99 wt % deionized water.

2. A post-CMP cleaning solution for cleaning microelectronic substrates comprising:
0.033 to 0.140 wt % tetramethylammonium hydroxide;
0.06 to 0.30 wt % monoethanolamine;
0.013 to 0.09 wt % gallic acid;
balance deionized water.

3. A post-CMP cleaning solution for cleaning microelectronics substrates comprising:
0.122 to 1.55 wt % tetramethylammonium hydroxide;
0.220 to 3.48 wt % monoethanolamine;
0.084 to 1.36 wt % gallic acid;
balance deionized water.

4. A cleaning solution for cleaning microelectronic substrates comprising:
1 part a concentrate consisting essentially of tetramethyl ammonium hydroxide in an amount in the range from about 1.75 wt % to 8.0 wt %, monoethanolamine in an amount in the range of from about 2.75 wt % to about 14.4 wt %, gallic acid in an amount in the range from about 1.0 wt % to about 5.6 wt %, balance deionized water; and 100 parts deionized water.

5. A cleaning composition according to claim 4 wherein said concentrate consists essentially of 5.0 wt % tetramethyl ammonium hydroxide, 9.0 wt % methanolamine, 3.6 wt % gallic acid, balance deionized water.

6. A cleaning solution for cleaning microelectronic substrates, comprising:
one part of a concentrate consisting essentially of tetramethyl ammonium hydroxide in an amount in the range of about 8.0 wt % to about 12.4 wt %, monoethanolamine in an amount in the range from about 14.4 wt % to about 27.8 wt %, gallic acid in an amount in the range from about 5.6 wt % to about 10.9 wt %, balance deionized water; and 50 to 200 parts deionized water.

7. A cleaning solution according to claim 6 containing 100 parts deionized water.

8. A cleaning solution according to claim 6 containing 200 parts deionized water.
